(19) United States
(12) Patent Application Publication
(10) Pub. No.: US 2012/0019503 A1
(43) Pub. Date: Jan. 26, 2012

(54) FRAME BUFFER PIXEL CIRCUIT, METHOD OF OPERATING THE SAME, AND DISPLAY DEVICE HAVING THE SAME

(75) Inventor: Sang Rok LEE, Seoul (KR)

(73) Assignee: NEX-I SOLUTION. CO., LTD, Chungcheongbuk-Do (KR)

(21) Appl. No.: 13/188,468

(22) Filed: Jul. 22, 2011

(30) Foreign Application Priority Data
Jul. 22, 2010 (KR) 10-2010-0070891

(51) Int. Cl. G09G 5/00

(52) U.S. Cl. 345/211

(57) ABSTRACT

Provided are a frame buffer pixel circuit, a method of operating the same, and a display device having the same. The frame buffer pixel circuit includes a first switching unit configured to transfer image data in response to a first actuating signal, a first charging unit configured to charge the image data, a second switching unit configured to supply a reference voltage in response to a second actuating signal, a third switching unit configured to adjust and transfer the reference voltage according to a charge amount, and a second charging unit configured to charge or discharge according to the reference voltage, wherein the reference voltage is supplied as a discharge voltage discharging the second charging unit and a charge voltage charging the second charging unit.

### CROSS-REFERENCE TO RELATED APPLICATION

This application claims priority to Korean Patent Application No. 10-2010-0070891 filed on Jul. 22, 2010 and all the benefits accruing therefrom under 35 U.S.C. §119, the contents of which are incorporated by reference in their entirety.

### BACKGROUND

The present disclosure relates to a frame buffer pixel circuit, and more particularly, to a frame buffer pixel circuit capable of further reducing a pixel size of a display device, a method of operating the frame buffer pixel circuit, and a display device having the frame buffer pixel circuit.

Recently, liquid crystal displays (LCDs) are widely spread and used for display terminals of office automation (OA) apparatuses as well as small-sized display devices. Among various types of LCDs, LCDs integrated with driving circuits have been known in which driving circuits to drive pixel circuits are also formed on the substrate where the pixel circuits are formed. In addition, liquid crystal on silicon (LCOS) technology has been known, in which pixel circuits and driving circuits are formed on a semiconductor substrate instead of an insulating substrate.

Such display devices include a display panel where a liquid crystal layer is formed between a pair of insulating substrates at least one of which is comprised of a transparent substrate. In a display panel, a plurality of pixels is arranged in a matrix form, and each pixel includes a frame buffer pixel circuit for transmitting image data to a pixel. Therefore, an image data signal is transmitted to a pixel through the frame buffer pixel circuit, and an image is thus displayed by the pixel.

Referring to FIG. 1, a related art frame buffer pixel circuit includes first and second transistors M11 and M12, a memory capacitor Cmem, and a liquid crystal capacitor Clcd. In the frame buffer pixel circuit, the first transistor M11 is driven in response to a write signal WRITE so that charges corresponding to the electric potential of a data signal DATA are stored in the memory capacitor Cmem, and the second transistor M12 is driven in response to a read signal READ so that charges corresponding to the voltage of the memory capacitor Cmem are stored in the liquid crystal capacitor Clcd.

However, when the read signal READ is applied to the related art frame buffer pixel circuit, the memory capacitor Cmem and the liquid crystal capacitor Clcd are short-circuited thereby sharing charges therebetween. That is, the memory capacitor Cmem becomes equal in voltage level to the liquid crystal capacitor Clcd after the read signal READ is applied. Accordingly, to solve a charge sharing problem, the capacitance of the memory capacitor Cmem should be significantly greater than the capacitance of the liquid crystal capacitor Clcd. Furthermore, since the liquid crystal capacitor Clcd should have a capacitance enough to keep image information during one frame, it is not easy to form both of the liquid crystal capacitor Clcd and the memory capacitor Cmem, whose capacitance is at least 10 times greater than that of the liquid crystal capacitor Clcd in a pixel with about 10 μm pitch. Moreover, the related art frame buffer pixel circuit does not have a discharging means for discharging charges stored in the liquid crystal capacitor Clcd. That is, charges corresponding to a data signal of a previous image are left in the liquid crystal capacitor Clcd, and thus charges corresponding to a data signal of a current image cannot be correctly stored in the liquid crystal capacitor Clcd. Consequently, an actual voltage level of the liquid crystal capacitor Clcd varies with the data signal of the previous image.

To overcome the limitation of the frame buffer pixel circuit in FIG. 1, another related art frame buffer pixel circuit has been suggested, which includes first to fourth transistors M21 to M24, a liquid crystal capacitor Clcd, and a parasitic capacitor Cgs between a gate and a source of the third transistor M23. Herein, the parasitic capacitor Cgs acts as a memory capacitor. In the frame buffer pixel circuit, the third transistor M23 is driven according to a pull-down signal PULLDOWN before a pull-up voltage PULLUP corresponding to a data signal of a current image is applied to the fourth transistor M24, so that charges accumulated in the liquid crystal capacitor Clcd are discharged. Therefore, even though the data signal of the current image is applied to have an electric potential lower than a data signal of a previous image, it is possible to display the current image properly.

However, this related art frame buffer pixel circuit causes pixel size to be increased because the fourth transistor M24 is additionally provided to discharge charges accumulated in the liquid crystal capacitor Clcd. Accordingly, as the pixel size is increased, the number of pixels provided in a display panel with the same size is decreased.

### SUMMARY

The present disclosure provides a frame buffer pixel circuit capable of reducing a pixel size, a method of operating the frame buffer pixel circuit, and a display device having the frame buffer pixel circuit.

The present disclosure also provides a frame buffer pixel circuit capable of discharging electric charges corresponding to a data signal of a previous image which are stored in a liquid crystal capacitor even though a transistor driven in response to a pull-down signal is removed, a method of driving the frame buffer pixel circuit, and a display device having the frame buffer pixel circuit.

The present disclosure also provides a frame buffer pixel circuit capable of discharging electric charges corresponding to a previous image data signal stored in a liquid crystal capacitor before a current image data signal is applied, and charging new image data by sequentially applying a ground or power supply voltage to the liquid crystal capacitor according to a read signal, a method of driving the frame buffer pixel circuit, and a display device having the frame buffer pixel circuit,

The present disclosure also provides a frame pixel circuit capable of compensating for a voltage loss caused by electric discharge by applying a bootstrap voltage to at least one of a pixel capacitor and a memory capacitor, a method of driving the frame buffer pixel circuit, and a display device having the frame buffer pixel circuit.

The present disclosure also provides a frame buffer pixel circuit capable of realizing column inversion, row inversion and dot inversion for DC balance adjustment by applying a bootstrap voltage to at least one of a pixel capacitor and a memory capacitor, a method of driving the frame buffer pixel circuit, and a display device having the same.

In accordance with an exemplary embodiment, a frame buffer pixel circuit includes: a first switching unit configured to transfer image data in response to a first actuating signal; a first charging unit configured to charge the image data; a second switching unit configured to supply a reference voltage in response to a second actuating signal; a third switching unit configured to adjust and transfer the reference voltage according to a charge amount; and a second charging unit configured to charge or discharge according to the reference voltage, wherein the reference voltage is capable of being supplied as a discharge voltage discharging the second charging unit and a charge voltage charging the second charging unit.

The first switching unit may include an N-type transistor, a P-type transistor, and a transmission gate comprising an N-type transistor and a P-type transistor.

The first charging unit may be a memory capacitor formed on a substrate, and the second charging unit may include a pixel capacitor connected to the memory capacitor.

The memory capacitor and the pixel capacitor each comprising a capacitor structure including an insulation layer disposed between a diffusion layer and a conductive layer, a capacitor structure including a conductive material and an insulating material disposed within a trench, or a capacitor structure including an insulation layer disposed between conductive layers.

The conductive layer may include doped polysilicon or metal.

A bootstrap voltage is configured to be supplied to at least one of the pixel capacitor and the memory capacitor.

The second and third switching units may include an N-type transistor and a P-type transistor.

A gate-source voltage of the third switching unit may be configured higher than a threshold voltage of the third switching unit such that discharge current can flow.

The first actuating signal may be a write signal and the second actuating signal may be a read signal.

The second switching unit is configured to supply the discharge voltage for a first time after the second actuating signal is activated and is configured to supply the charge voltage for a second time after the first time.

In accordance with another exemplary embodiment, a method of operating a frame buffer pixel circuit includes: charging data of a current image in response to a first actuating signal; discharging data of a previous image by supplying a discharge voltage for a first time of a second actuating signal; and supplying a charge voltage for a second time of the second actuating signal after the first time, wherein the data of the current image is charged adjusting a supply amount of the charge voltage according to the data of the current image.

The second actuating signal may be activated after the first actuating signal is deactivated.

The operating method may include supplying a bootstrap voltage before or after applying the second actuating signal after next image data is stored.

In accordance with yet another exemplary embodiment, a display device includes: a display panel including a display unit where a plurality of pixels are arranged in a matrix form, a row driver configured to supply first and second actuating signals for selecting the pixels, and a column driver configured to supply image data to the selected pixels; a display control unit configured to supply the first and second actuating signals and the image data for driving the display panel; and a voltage generation unit configured to generate a charge voltage and a discharge voltage, wherein each of the pixels may include a frame buffer pixel circuit including a first charging unit configured to charge the image data and a second charging unit configured to charge according to the charge voltage adjusted according to the image data charged in the first charging unit, wherein the second charging unit is configured to discharge data of a previous image to the discharge voltage before data of a current image are applied and is configured to charge the data of the current image through the charge voltage.

The frame buffer pixel circuit may include a first switching unit configured to transfer the image data to the first charging unit in response to the first actuating signal; a second switching unit configured to supply the discharge voltage or the charge voltage to the second charging unit in response to the second actuating signal; and a third switching unit configured to adjust the charge voltage according to a charge amount of the first charging unit and configured to transfer the adjusted charge voltage to the second charging unit.

The third switching unit may include an N-type transistor and a P-type transistor in which a gate-source voltage is configured higher than a threshold voltage.

The third switching unit is capable of supplying the discharge voltage to the second charging unit regardless of the charge amount of the first charging unit for the second charging unit to discharge the data of the previous image.

A bootstrap voltage generation unit configured to supply a bootstrap voltage to at least one of the first and second charging units may be further included.

A bootstrap voltage divider configured to differently apply the bootstrap voltage to the pixels between the display unit and the bootstrap voltage generation unit may be further included.

### BRIEF DESCRIPTION OF THE DRAWINGS

Exemplary embodiments can be understood in more detail from the following description taken in conjunction with the accompanying drawings, in which:

FIGS. 1 and 2 are circuit diagrams of related art frame buffer pixel circuits;

FIG. 3 is a schematic diagram illustrating a display device in accordance with an exemplary embodiment;

FIG. 4 is a circuit diagram of a frame buffer pixel circuit in accordance with an exemplary embodiment;

FIG. 5 is a simulation result graph illustrating a driving method of a frame buffer pixel circuit in accordance with an exemplary embodiment;

FIG. 6 is a waveform diagram illustrating a read signal and a reference voltage when the frame buffer pixel circuit in accordance with an exemplary embodiment is driven;

FIGS. 7 to 9 are circuit diagrams of a frame buffer pixel circuit in accordance with another exemplary embodiment;

FIGS. 10 and 11 are circuit diagrams of a frame buffer pixel circuit in accordance with still other exemplary embodiments;

FIG. 12 is a schematic diagram of a display device in accordance with another exemplary embodiment;

FIGS. 13 and 14 are circuit diagrams of a frame buffer pixel circuit in accordance with a modified example;

FIGS. 15 and 16 are schematic diagrams of display devices in accordance with modified examples;

FIG. 17 is a schematic diagram of a bootstrap voltage divider which is applied in the exemplary embodiments; and

FIGS. 18 and 19 are circuit diagrams of a frame buffer pixel circuit in accordance with yet another exemplary embodiment.

### DETAILED DESCRIPTION OF EMBODIMENTS

Hereinafter, specific embodiments will be described in detail with reference to the accompanying drawings. The present invention may, however, be embodied in different forms and should not be limited to the embodiments set forth herein. Rather, these embodiments are provided so that this disclosure will be thorough and complete, and will fully convey the scope of the present invention to those skilled in the art.

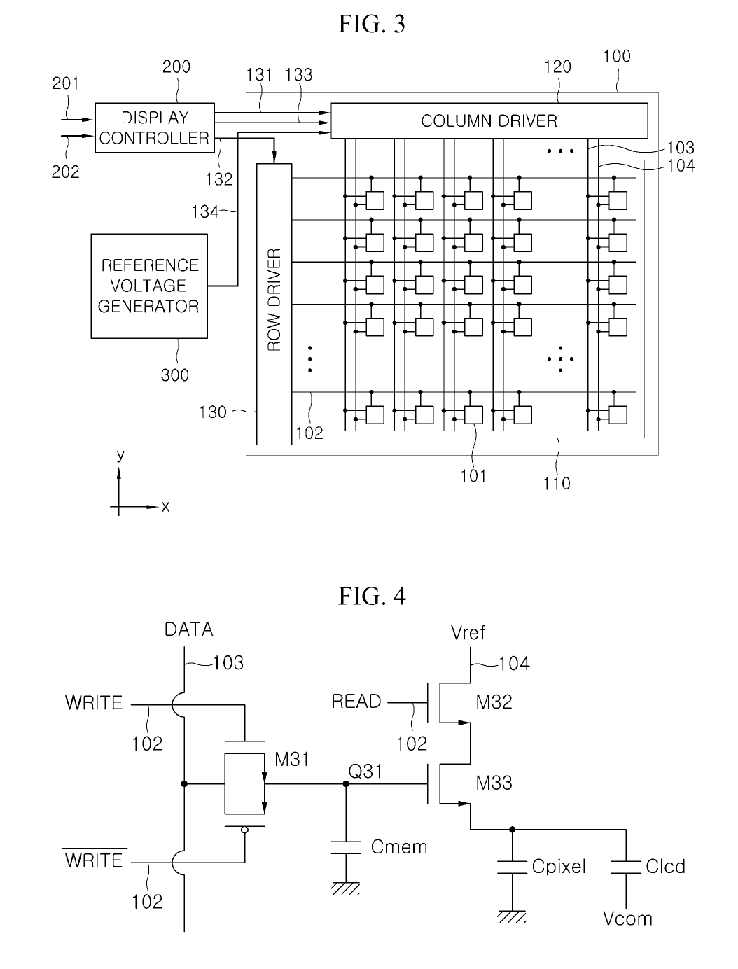

FIG. 3 is a schematic block diagram illustrating a display device in accordance with an exemplary embodiment.

Referring to FIG. 3, the display device in accordance with the exemplary embodiment includes a display panel 100 configured to display an image, a display controller 200 configured to control the operation of the display panel 100, and a reference voltage generator 300 configured to generate a reference voltage Vref. Furthermore, the display panel 100 may include a display unit 110, a column driver 120, and a row driver 130.

The display panel 100 includes a display unit 110 having a plurality of pixels 101 arranged in a matrix form, a column driver 120 configured to supply image data to the display unit 110, and a row driver 130 configured to select the pixels in a row on which the image data is to be stored. Here, the display unit 110, the column driver 120 and the row driver 130 may be formed on the same substrate. However, the display unit 110 may be formed on a substrate, and the column driver 120 and the row driver 130 may be provided such that they are connected to the display unit 110 at an outer side of the display unit 110. In the display unit 110, the plurality of pixels 101 are arranged in a matrix form. In each of the pixels 101, a pixel electrode and a counter electrode are disposed facing each other, and a liquid crystal layer is provided therebetween. An image is displayed using the fact that the alignment or directional distribution of liquid crystal molecules are changed to thereby change the retardation amount (Δnd) at a specific optical axis of the liquid crystal layer if a voltage is applied to the pixel electrode and the counter electrode to induce an electric potential difference therebetween. The plurality of pixels 101 are respectively disposed at intersections of a plurality of actuating signal lines 102 extending in one direction, e.g., horizontal direction (x-direction), and a plurality of image signal lines 103 extending in another direction, e.g., vertical direction (y-direction), and a frame buffer pixel circuit is provided in each of the pixels 101. Meanwhile, a plurality of reference voltage supply lines 104 may be provided, which cross the actuating signal lines 102 and are parallel with the image signal lines 103. That is, the plurality of pixels 101 arranged in a horizontal direction are commonly connected to the actuating signal line 102, and are respectively connected to the pluralities of image signal lines 103 and reference voltage supply lines 104 which differ from each other. Also, the plurality of pixels 101 arranged in a vertical direction are commonly connected to one of the image signal lines 103 and one of the reference voltage supply lines 104, and are respectively connected to the plurality of different actuating signal lines 102. Herein, the actuating signal line 102 is used for transferring an actuating signal such as a write signal WRITE and a read signal READ by selecting one of the pixels 101, and the image signal line 103 is used for transferring an image data signal to at least one of the pixels selected. The reference voltage supply line 104 is used for supplying a reference voltage Vref to each of the pixels 101.

The display controller 200 is connected to an image outputting terminal of an external device (not shown) such as a personal computer, DVD, PMP, and a cell phone through an external control signal line 201. The display controller 200 receives an external control signal from the outside through the external control signal line 201, and generates a control signal controlling the column driver 120 and the row driver 130 using the external control signal. A display data signal line 202 is connected to the display controller 200, and the display controller 200 thus receives display data from an external device. The display data is transmitted in a predetermined order so as to form an image displayed on the display panel 100, and received by the display controller 200. For example, pixel data of the first row are sequentially transmitted from an external device in a right direction from the pixel 101 disposed at the left top corner of the display panel 100. Then, pixel data of the respective rows are sequentially transmitted from top to bottom through the external device. The display controller 200 generates image data based on display data, and supplies the image data to the column driver 120 in sequence when the display panel 100 displays image. To this end, the display controller 200 transfers the control signal to the column driver 120 and the row driver 130 through control signal lines 131 and 132, and transfers image data to the column driver 120 through an image data transmission line 133. That is, the column driver 120 and the row driver 130 are controlled and driven by the display controller 200, and the image data are transferred to the display unit 110 through the column driver 120. Meanwhile, although FIG. 3 illustrates a single image data transmission line 133, plural image data transmission lines 133 may be used instead.

The column driver 120 is provided in a periphery of the display unit 110, for example, at one side of the display unit 110 in a vertical direction (y-direction). The plurality of image signal lines 103 are arranged along the vertical direction (y-direction) from the column driver 120. The image signal line 103 is connected to the plurality of pixels 101, and thus transfers the image signal to the pixel 101. That is, the image data generated from the display controller 200 is transferred to the column driver 120 through the image data transmission line 133, and then transferred to the display unit 110 through the image signal line 103. The column driver 120 receives the reference voltage Vref and transfers the reference voltage Vref to the display unit 110 through the reference voltage supply line 104. The reference voltage Vref is generated as a power supply voltage VDD or ground voltage VSS, and transferred to the pixel 101 in response to the actuating signal, i.e., read signal READ, transferred through the row driver 130. That is, the reference voltage Vref is applied as the ground voltage Vss during a predetermined period when the read signal READ is being applied, however, the reference voltage Vref is applied as the power supply voltage VDD during the other periods. Accordingly, the previous image data stored in the selected pixel 101 are removed while the reference voltage Vref is being applied as the ground voltage VSS.

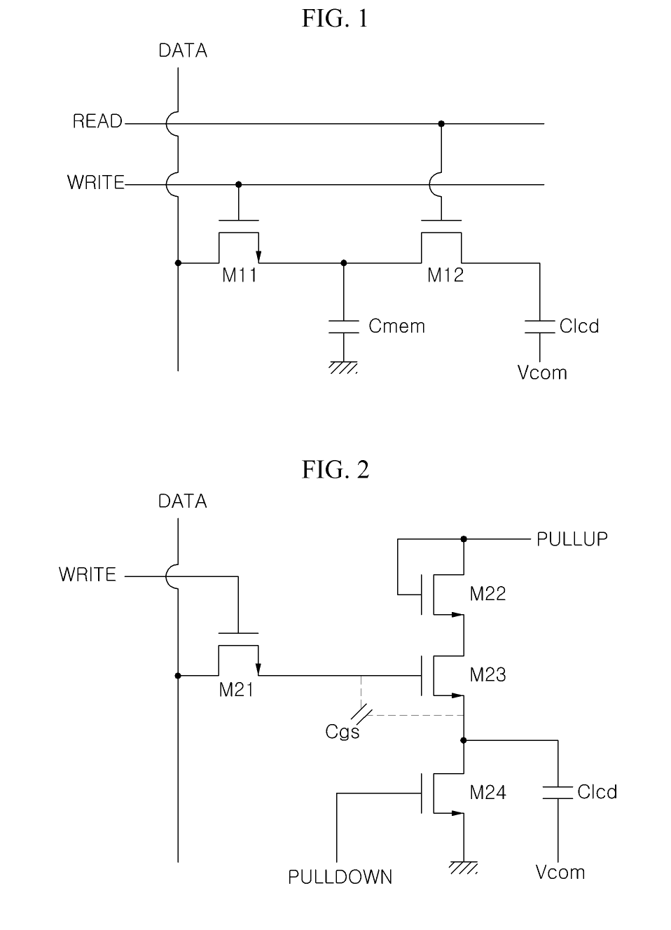

The row driver 130 is provided in a periphery of the display unit 110, for example, at one side of the display unit 110 in a horizontal direction (x-direction). The plurality of actuating signal lines 102 are arranged along the horizontal direction (x-direction) from the row driver 130. The actuating signal line 102 is connected to the plurality of pixels 101, and the actuating signal for driving the frame buffer pixel circuit provided in the pixel 101 is transferred through the actuating signal line 102. Each of the frame buffer pixel circuit includes at least one switching element, a storage element, and the like. That is, the control signal generated from the display controller 200 is transferred to the row driver 130 through the control signal transmission line 132, and then transferred to the display unit 110 through the actuating signal line 102, thereby turning on/off the switching element of the frame buffer pixel circuit of the selected pixel 101. The actuating signal transferred to the pixel 101 through the actuating signal line 102 may include a write signal WRITE and a read signal READ. The write signal WRITE and the read signal READ may be transferred through the respective actuating signal lines 102 in the case where two actuating signal lines 102 are connected to one pixel 101. Although FIG. 1 illustrates an actuating signal line 102, two separate actuating signal lines 102 may be connected to one pixel 101 in order to transfer the write signal WRITE and the read signal READ. Therefore, the pixels 101 are selected by the row driver 130, and the reference voltage Vref and the image data are transferred to the selected pixels 101 by the column driver 120 thereby removing the previous image signal remaining in the pixel 101 and displaying a current image.

The reference voltage generator 300 generates the reference voltage Vref and supplies the reference voltage Vref to the column driver 120 through a voltage supply line 134. Herein, the reference voltage Vref is generated as the power supply voltage VDD and ground voltage Vss. That is, the reference voltage generator 300 generates and supplies the power supply voltage VDD and ground voltage Vss to the column driver 120, and the column driver 120 selectively supplies the power supply voltage VDD or ground voltage Vss to the pixel 101 when the pixel 101 is driven. Meanwhile, although the power supply voltage VDD and ground voltage Vss are used as examples of the reference voltage Vref, the reference voltage Vref may be a high voltage enabling the image data to be displayed, or a low voltage enabling the previous image data stored in the pixel 101 to be discharged.

The display device in accordance with the exemplary embodiment generates the reference voltage Vref of the power supply voltage VDD and ground voltage Vss, and supplies the reference voltage Vref to the pixel 101 of the display unit 110 through the column driver 120. Therefore, in the display device in accordance with the exemplary embodiment, the ground voltage Vss is supplied first to the pixel to thereby remove the previous image data stored in the pixel 101 before image data to be displayed currently is supplied, and thereafter the current image data is supplied thereby displaying a current image. Such an operation is possible by controlling the frame buffer pixel circuit provided in each pixel 101. Hereafter, various embodiments of the frame buffer pixel circuit and driving methods thereof will be described in detail.

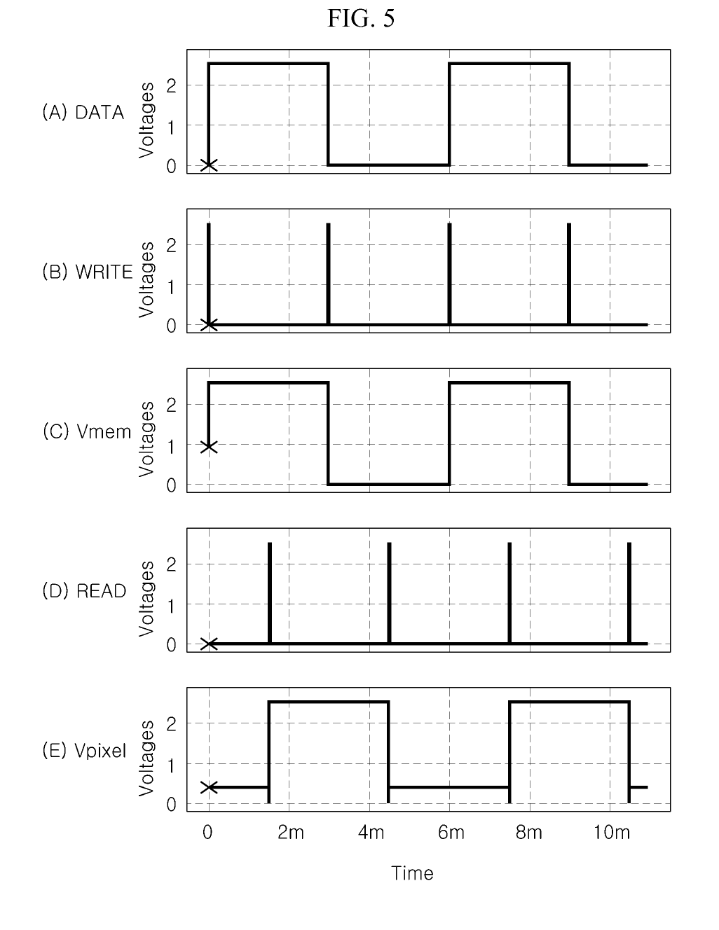

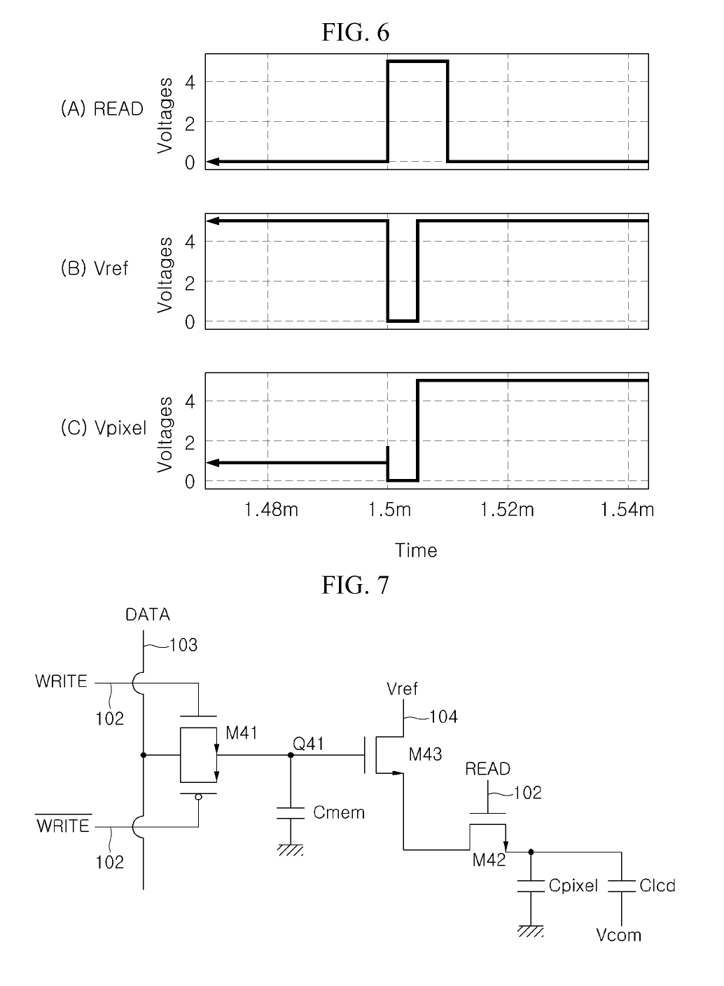

FIG. 4 is a circuit diagram of a frame buffer pixel circuit in accordance with an exemplary embodiment, and FIG. 5 is a simulation waveform diagram of a frame buffer pixel circuit in accordance with an exemplary embodiment. FIG. 6 is a waveform diagram of a reference voltage according to a read signal for illustrating the operation of the frame buffer pixel circuit in accordance with an exemplary embodiment.

Referring to FIG. 4, the frame buffer pixel circuit in accordance with an exemplary embodiment includes: a first transistor M31 configured to transfer a data signal DATA in response to a write signal WRITE and a write bar signal/WRITE; a memory capacitor Cmem configured to charge electric potential corresponding to a data voltage transferred through the first transistor M31; a second transistor M32 configured to apply a reference voltage Vref in response to a read signal READ; a third transistor M33 configured to transfer the reference voltage Vref transferred through the second transistor M32 in response to a charged potential of the memory capacitor Cmem; and a pixel capacitor Cpixel and a liquid crystal capacitor Clcd configured to store electric charges corresponding to the reference voltage Vref transferred through the third transistor M33. Herein, the liquid crystal capacitor Clcd, which is formed by a liquid crystal layer interposed between two substrates, is not formed on a silicon substrate. Moreover, a charging voltage enabling the pixel capacitor Cpixel and liquid crystal capacitor Clcd to be charged, for example, a power supply voltage VDD, and a discharging voltage enabling the pixel capacitor Cpixel and liquid crystal capacitor Clcd to be discharged, for example, the ground voltage Vss, are applied in sequence as the reference voltage Vref.

The first transistor M31 is connected between a first node Q31 and an image signal line 103 to which the data signal DATA is applied. The first transistor M31 is driven according to the write signal WRITE and write bar signal/WRITE applied through an actuating signal line 102. Herein, the write bar signal/WRITE is an inversion signal of the write signal WRITE. The first transistor M31 may be a transmission gate configured by an N-type transistor and a P-type transistor. If the write signal WRITE is activated at a high level, the N-type transistor is driven in response to the write signal WRITE, and the P-type transistor is driven in response to the write bar signal/WRITE. On the contrary, if the write signal WRITE is activated at a low level, the P-type transistor may be driven in response to the write signal WRITE, and the N-type transistor may be driven in response to the write bar signal/WRITE. The first transistor may be configured by only N-type or P-type transistor. The data signal DATA transferred through the first transistor M31 maintains electric potential corresponding to the image data to be displayed currently.

The memory capacitor Cmem is connected between the first node Q31 and the ground terminal Vss. The memory capacitor Cmem is charged according to the electric potential of the data signal DATA transferred through the first transistor M31. The memory capacitor Cmem charges the electric potential corresponding to the transferred data signal DATA when the first transistor M31 is turned on, and keeps the charged state when the transfer transistor M31 is turned off. That is, when the write signal WRITE of high level is applied to turn on the first transistor M31, the memory capacitor Cmem charges the electric potential corresponding to the data signal DATA. When the write signal WRITE of low level is applied to turn off the first transistor M31, the memory capacitor Cmem keeps the charged potential. The memory capacitor Cmem may be connected between the first node Q31 and the power supply terminal VDD.

The second transistor M32 is connected between the third transistor M33 and a reference voltage supply line 104 to which the reference voltage Vref is applied, and driven in response to the read signal READ. The second transistor M32 may be an N-type transistor for which the read signal READ is activated at high level, or may be a P-type transistor for which the read signal READ is activated at low level. In the exemplary embodiment, an N-type transistor is used for the second transistor M32. The read signal READ is activated after a predetermined time after the write signal WRITE is activated. For instance, the read signal READ may be applied after the write signal WRITE for transferring the data signal DATA of a current image is applied and before the write signal WRITE for transferring the data signal DATA of a next image is applied. Also, the reference voltage Vref is either the power supply voltage VDD or the ground voltage Vss. The reference voltage Vref is applied as the ground voltage Vss at the same time when the read signal READ is applied, is kept as the ground voltage Vss for a predetermined time while the read signal READ is applied, and then is applied as the power supply voltage VDD. For instance, as illustrated in FIG. 6, if the read signal READ is applied as high level for a time of T, the reference voltage Vref is applied as the ground voltage Vss for a time of T/2 after the read signal READ is applied, and then is applied as the power supply voltage VDD for a time of T/2.

The third transistor M33 is connected between the second transistor M32 and the pixel and liquid crystal capacitors (Cpixel and Clcd), and is driven according to an electric potential of the first node Q31. Such a third transistor M33 may be an N-type transistor or may be a P-type transistor as a Source Follower (Common Drain) amplifier. In the exemplary embodiment, an N-type transistor is used for the third transistor M33. That is, the third transistor M33 is driven according to an amount of charges charged in the memory capacitor Cmem to thereby transfer the reference voltage Vref applied through the second transistor M32 to the pixel capacitor Cpixel and the liquid crystal capacitor Clcd so that the pixel capacitor Cpixel and the liquid crystal capacitor Clcd are charged or discharged. Since the memory capacitor Cmem is charged with an electric potential corresponding to the data signal DATA of a current image, the third transistor M33 consequently charges the electric potential corresponding to the data signal DATA of a current image to the pixel capacitor Cpixel and the liquid crystal capacitor Clcd. Meanwhile, for the third transistor M33, a gate-source voltage Vgs should be configured higher than a threshold voltage Vth. This is because charges charged in the pixel capacitor Cpixel and the liquid crystal capacitor Clcd should be discharged when the reference voltage Vref is applied as the ground voltage Vss through the third transistor M33, and the third transistor M33 cannot be turned on in the case that an electric potential lower than the threshold voltage Vth of the third transistor M33 is charged to the memory capacitor Cmem. Therefore, the gate-source voltage Vgs of the third transistor M33 should be configured higher than the threshold voltage Vth of the third transistor M33 by charging the Cmem higher than the threshold voltage Vth so that charges may pass through the third transistor M33. Preferably, a minimum gate-source voltage Vgs of the third transistor M33 is configured higher than the threshold voltage Vth, e.g., from approximately 0.7 V to approximately 1.0 V.

The pixel capacitor Cpixel and the liquid crystal capacitor Clcd are charged with an electric potential corresponding to the data signal DATA in response to the read signal READ. Therefore, the pixel capacitor Cpixel and the liquid crystal capacitor Clcd are charged with an electric potential of the data signal DATA corresponding to a current image, and thereby displays the current image. Also, the pixel capacitor Cpixel and the liquid crystal capacitor Clcd should discharge charges charged corresponding to a previous image before the data signal DATA corresponding to a current image is applied. As described above, the previously charged charges are discharged through the third transistor M33 maintaining the gate-source voltage Vgs higher than the threshold voltage Vth when the reference voltage Vref of the ground voltage Vss is applied and the second transistor M32 is driven in response to the read signal READ.

The memory capacitor Cmem and the pixel capacitor Cpixel may be respectively implemented under a pixel electrode. For instance, the first to third transistors M31 to M33 may be formed on a substrate under the pixel electrode, and a plurality of conductive layers and insulation layers may be formed between the first to third transistors M31 to M33 and the pixel electrode. Herein, a diffusion layer may be formed on a substrate and an insulation layer may be provided between the diffusion layer and a conductive layer so that the memory capacitor Cmem and the pixel capacitor Cpixel are implemented, or a trench may be formed on a substrate and conductive material and insulation material may be layered within the trench so that the memory capacitor Cmem and the pixel capacitor Cpixel are implemented. Also, an insulation layer may be provided between conductive layers for implementing the memory capacitor Cmem and the pixel capacitor Cpixel. Herein, the conductive layer includes a metal layer or a polysilicon layer. Also, the liquid crystal capacitor Clcd is implemented providing a liquid crystal layer between a pixel electrode and a counter electrode.

A method for driving the frame buffer pixel circuit in accordance with the exemplary embodiment will be described referring to a simulation waveform of FIG. 5 and a reference voltage waveform according to a read signal of FIG. 6. Meanwhile, in FIGS. 5 and 6, Vmem and Vpixel respectively denote voltages of the memory capacitor Cmem and the pixel capacitor Cpixel.

Firstly, if the write signal WRITE is applied as, e.g., high level, and the write bar signal/WRITE is accordingly applied as low level, the first transistor M31 is driven so that the data signal DATA is transferred to the memory capacitor Cmem. Therefore, the memory capacitor Cmem is charged according to an electric potential of the data signal DATA. Herein, the reference voltages Vref maintains the power supply voltage VDD as illustrated in FIG. 6 and cannot be applied because the read signal READ keeps low level so that the second transistor M32 is turned off.

Thereafter, the read signal READ is applied as high level. Herein, during a predetermined period when the read signal READ maintains high level after the read signal READ is applied as high level, the reference voltage Vref is applied as the ground voltage Vss. For instance, when the read signal READ is applied high level for a time of T, the reference voltage Vref is applied as the ground voltage Vss for a time of T/2. Therefore, the second transistor M32 is turned on and the ground voltage Vss is transferred through the second transistor M32. Herein, since gate-source voltage Vgs is configured higher than the threshold voltage Vth for the third transistor M33, a current always flows. Therefore, the ground voltage Vss applied through the second transistor M32 is transferred to the pixel capacitor Cpixel and the liquid crystal capacitor Clcd through the third transistor M33. Accordingly, charges charged in the pixel capacitor Cpixel and the liquid crystal capacitor Clcd are discharged, and the pixel capacitor Cpixel and the liquid crystal capacitor Clcd maintain low level.

Thereafter, the read signal READ maintains high level, and the reference voltage Vref is changed and applied as the power supply voltage VDD. For instance, when the read signal READ is applied as high level for a time of T, the reference voltage Vref is applied as the ground voltage Vss for a time of T/2, and then, the reference voltage Vref is applied as the power supply voltage VDD for the remaining time. Consequently, the second transistor M32 maintains a turned-on state and the third transistor M33 is also turned on according to an amount of charges charged in the memory capacitor Cmem so that the pixel capacitor Cpixel and the liquid crystal capacitor Clcd are charged through the second and third transistors M32 and M33. Herein, since a turn-on degree of the third transistor M33 is adjusted according to a level of the data signal DATA of a current image, the pixel capacitor Cpixel and the liquid crystal capacitor Clcd are charged with an electric potential corresponding to the data signal DATA of the current image. Therefore, a pixel displays the current image.

As described above, in the frame buffer pixel circuit in accordance with the exemplary embodiment, the reference voltage Vref is applied as the ground voltage Vss during a predetermined period when the read signal READ is activated so that charges charged in the pixel capacitor Cpixel and the liquid crystal capacitor Clcd according to the data signal DATA of a previous image are discharged, and the reference voltage Vref is applied as the power supply voltage VDD during the remaining period when the read signal READ is activated so that the pixel capacitor Cpixel and the liquid crystal capacitor Clcd are charged with an electric potential corresponding to the data signal DATA of a current image. Therefore, unlike the related art frame buffer pixel circuit for which a pull-down transistor is needed for discharging the pixel capacitor Cpixel and the liquid crystal capacitor Clcd, a pull-down transistor is not needed, and thus a pixel size may be reduced.

Meanwhile, the reference voltage Vref may be commonly applied to selected pixels or all pixels synchronizing the reference voltage with the read signal. Therefore, charging and discharging operations of the liquid crystal capacitor Clcd may be completed within one cycle, and thus a control circuit for driving a pixel may be simply designed.

FIG. 7 is a circuit diagram illustrating a frame buffer pixel circuit in accordance with another exemplary embodiment.

Referring to FIG. 7, the frame buffer pixel circuit in accordance with the other exemplary embodiment includes: a first transistor M41 configured to transfer a data signal DATA in response to a write signal WRITE or a write bar signal/WRITE; a memory capacitor Cmem configured to charge electric potential of the data signal DATA transferred through the first transistor M41; a third transistor M43 configured to transfer a reference voltage Vref according to an amount of charges charged in the memory capacitor Cmem; a second transistor M42 configured to transfer the reference voltage Vref to a pixel capacitor Cpixel and a liquid crystal capacitor Clcd in response to a read signal READ; and the pixel capacitor Cpixel and the liquid crystal capacitor Clcd configured to be charged or discharged according to the reference voltage Vref transferred through the third and second transistors M43 and M42. Herein, the reference voltage Vref is either a ground voltage Vss or a power supply voltage VDD. In detail, the reference voltage Vref is supplied as the ground voltage Vss for a predetermined time after the read signal READ is activated, and then is supplied as the power supply voltage VDD. Also, the frame buffer pixel circuit in accordance with the other exemplary embodiment is operated in the same manner as described above referring to the simulation waveform of FIG. 5 and the reference voltage waveform of FIG. 6.

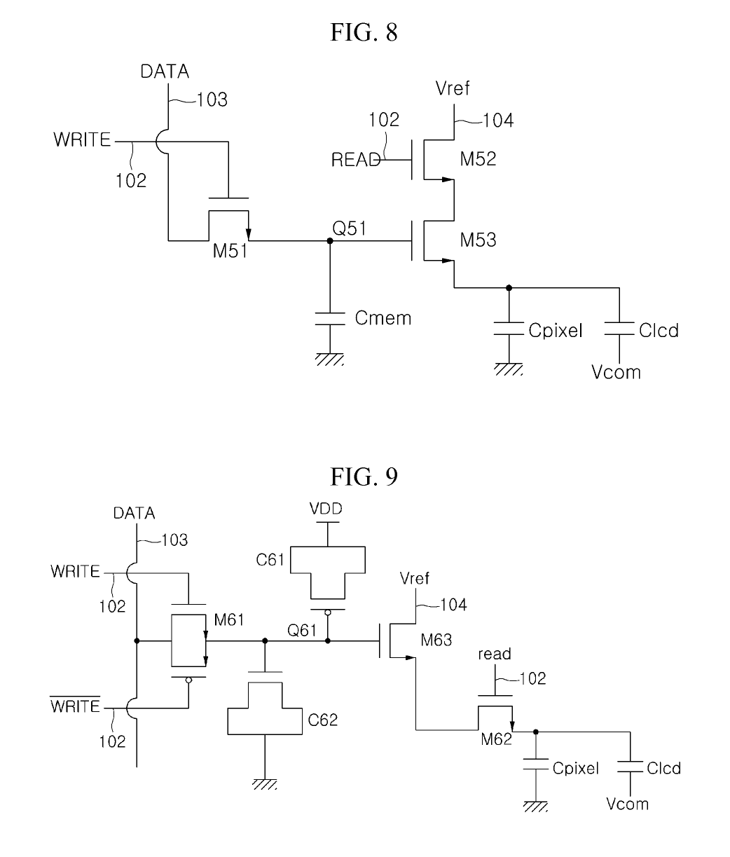

FIGS. 8 and 9 are circuit diagrams illustrating frame buffer pixel circuits in accordance with still other exemplary embodiments.

Referring to FIG. 8, a frame buffer pixel circuit in accordance with still another exemplary embodiment includes: a first transistor M51 configured to transfer a data signal DATA in response to a write signal WRITE; a memory capacitor Cmem configured to charge electric potential of the data signal DATA transferred through the first transistor M51; a second transistor M52 configured to transfer a reference voltage Vref in response to a read signal READ; a third transistor M53 configured to transfer the reference voltage Vref transferred through the second transistor M52 according to an amount of charges charged in the memory capacitor Cmem; and a pixel capacitor Cpixel and a liquid crystal capacitor Clcd configured to be charged or discharged according to the reference voltage Vref transferred through the second and third transistors M52 and M53. Herein, the reference voltage Vref is either a ground voltage Vss or a power supply voltage VDD. In detail, the reference voltage Vref is supplied as the ground voltage Vss for a predetermined time after the read signal READ is activated, and then is supplied as the power supply voltage VDD. For the frame buffer pixel circuit in accordance with the still other exemplary embodiment, an N-type transistor, i.e., M51, driven in response to the write signal WRITE may be used instead of the transfer transistor M31 driven in response to the write signal WRITE and the write bar signal/WRITE in comparison with the exemplary embodiment of FIG. 4. Furthermore, a P-type transistor driven in response to the write bar signal/WRITE can be used for M51.

FIG. 9 is a circuit diagram illustrating a frame buffer pixel circuit in accordance with yet another exemplary embodiment. A transistor capacitor is used for the memory capacitor Cmem of the frame buffer pixel circuit in accordance with the exemplary embodiment of FIG. 4. That is, a P-type capacitor C61 and an N-type capacitor C62 coupled to a first node Q61 are connected to each other in parallel. In the case of connecting the P-type capacitor C61 and the N-type capacitor C62 in parallel as a memory capacitor, a total capacitance is a sum of capacitance of the two capacitors, and the total capacitance of the combined capacitor does not drop below a minimum capacitance near a threshold voltage. For instance, capacitance of the N-type capacitor C62 is decreased near a threshold voltage of approximately 0.7 V of an N-type transistor; however, in the case of connecting the P-type capacitor C61 and the N-type capacitor C62 in parallel, the capacitance of the P-type does not change at the threshold voltage of the N-type transistor, thus total capacitance maintains above a minimum capacitance for normal operation.

Meanwhile, the frame buffer pixel circuit in accordance with the exemplary embodiments may be variously modified differently from the above description. Hereinafter, various exemplary embodiments or modified examples of the frame buffer pixel circuit and a display device provided with the same will be described.

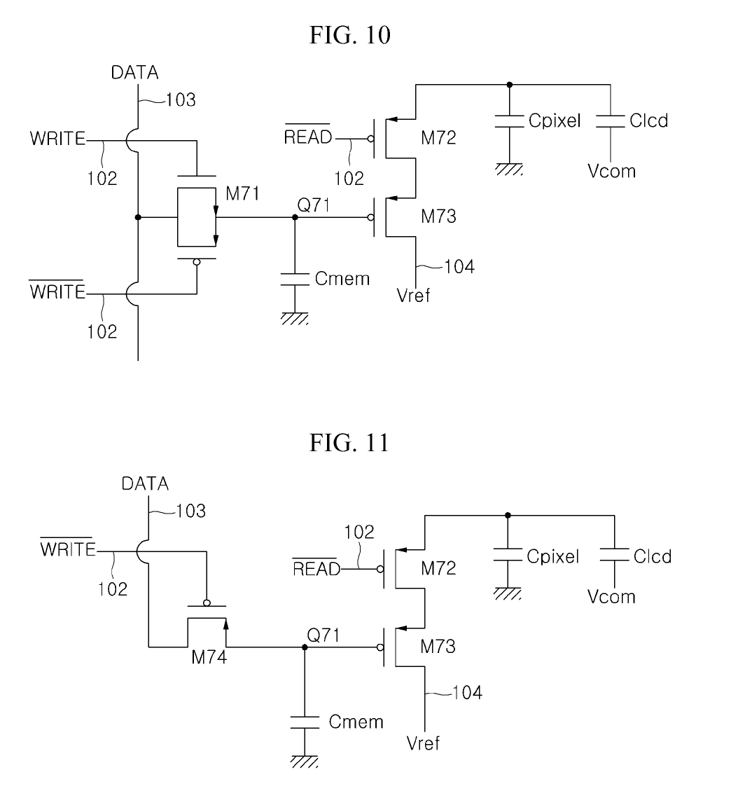

FIG. 10 is a circuit diagram illustrating a modified example of the frame buffer pixel circuit in accordance with the exemplary embodiments. Herein, a P-type transistor is used for the frame buffer pixel circuit. As illustrated in FIG. 10, second and third transistors M72 and M73 are configured by P-type transistors. The second transistor M72 is driven in response to a read bar signal /READ which is an inversion signal of a read signal READ, and the third transistor M73 transfers a reference voltage Vref. Herein, a minimum source-gate voltage Vsg is configured higher than a threshold voltage Vth for the third transistor M73.

Also, as illustrated in FIG. 11, a transistor M74 transferring a data signal DATA may be configured by a P-type transistor and may be driven in response to a write bar signal/WRITE.

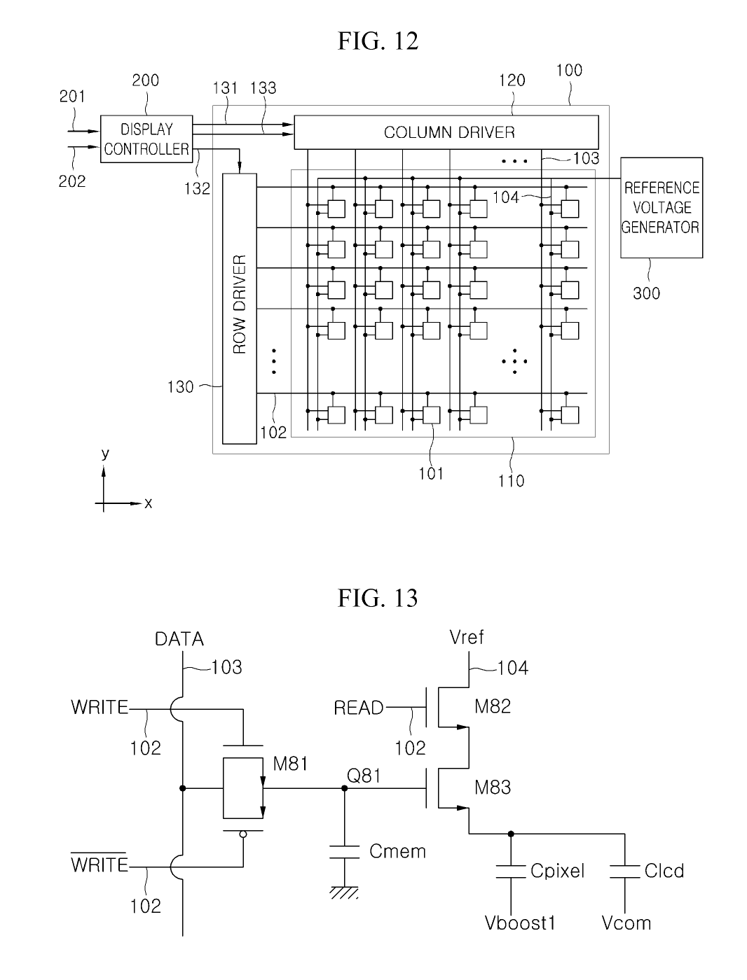

Meanwhile, in a display device in accordance with an exemplary embodiment, the reference voltage Vref generated from the reference voltage generator 300 may be transferred to each pixel 101 of the display unit 110 without passing through the column driver 120. That is, as illustrated in FIG. 12, the reference voltage generator 300 may be provided at one side of the display unit 110 and may be connected to the reference voltage supply line 104 connected to each pixel 101 of the display unit 110. In this case, the reference voltage supply line 104 may be directly connected to the reference voltage generator 300 without being connected to the column driver 120.

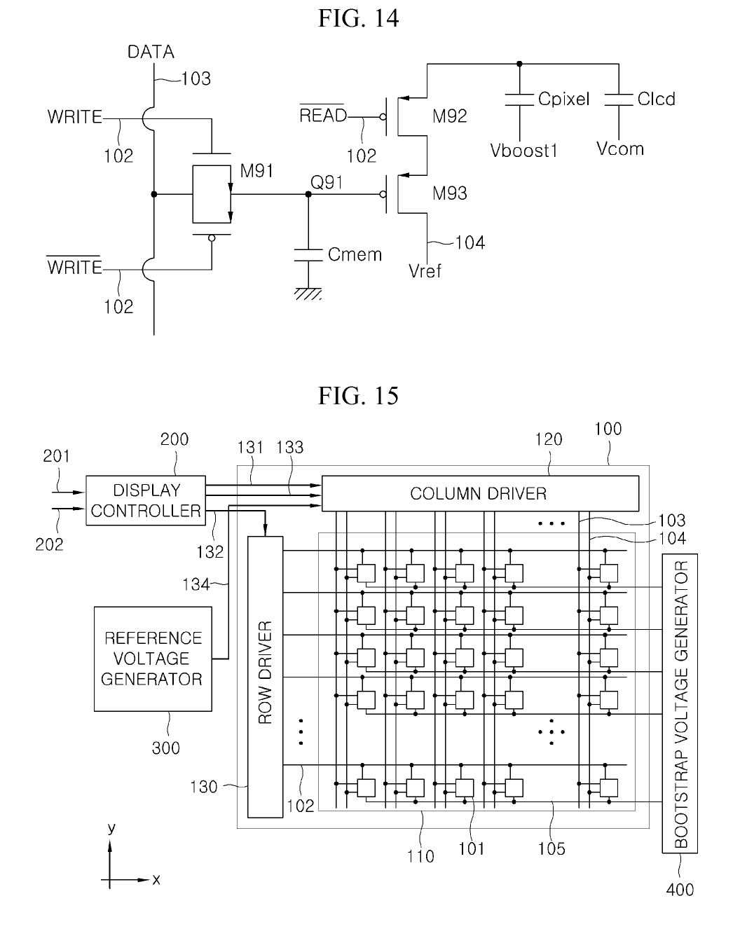

Meanwhile, for instance, image data of a first row are supplied in a right direction from the pixel 101 located at a top left corner, and image data of each row are supplied from top to bottom so that the display panel 100 displays an image in response to the read signal READ. Herein, while a current image is displayed, charges charged in the pixel capacitor Cpixel and the liquid crystal capacitor Clcd may be discharged due to leakage current over a time. That is, although the pixel capacitor Cpixel and the liquid crystal capacitor Clcd should maintain charges corresponding to a current image before the reference voltage Vref of low level is provided in response to the read signal READ, charges charged in the pixel capacitor Cpixel and the liquid crystal capacitor Clcd are naturally discharged. Accordingly, a current image becomes blurred as time passes, and thus the image cannot be correctly displayed. Therefore, charges discharged from the pixel capacitor Cpixel and the liquid crystal capacitor Clcd may be needed to be compensated. To this end, a bootstrap voltage Vboost is applied to the pixel capacitor in an exemplary embodiment. That is, as illustrated in FIG. 13, a bootstrap voltage Vboost1 is applied to the pixel capacitor Cpixel to compensate for the discharged charges. Of course, even in the case of configuring the frame buffer pixel circuit with P-type transistors as illustrated in FIG. 14, the bootstrap voltage Vboost1 is applied to the pixel capacitor Cpixel. Also, since discharge voltage is increasing as time passes, the discharge voltage may be compensated by increasing the applied bootstrap voltage as time passes. Also, the bootstrap voltage may be applied not only to compensate for the discharged charges but also to implemente column inversion in which a positive voltage and a negative voltage are repeatedly generated along a column or a row inversion in which a positive voltage and a negative voltage are repeatedly generated along a row for maintaining a DC balance of a liquid crystal. Of course, the bootstrap voltage may also be applied for implementing a dot inversion mixing the column inversion and the row inversion.

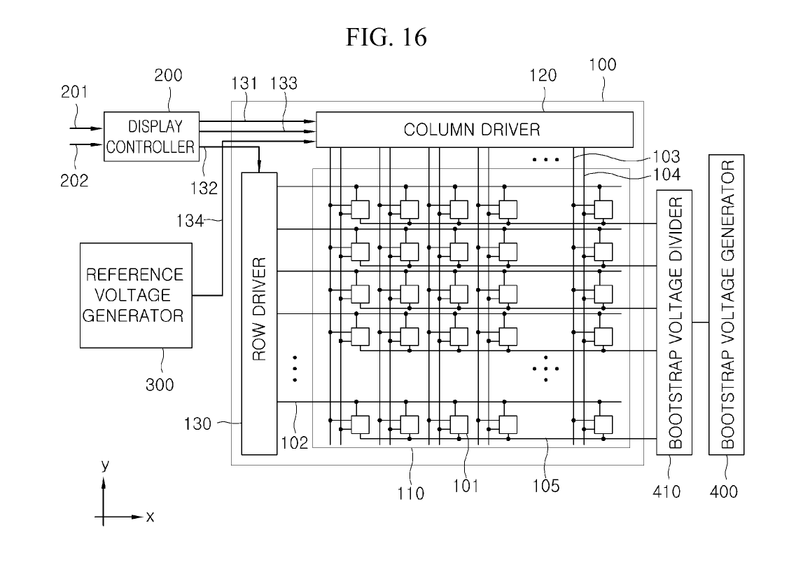

For applying the bootstrap voltage Vboost to the pixel capacitor Cpixel of each pixel 101, a bootstrap voltage supply line 105 connected to each pixel 101 should be provided, and the bootstrap voltage supply line 105 should be connected to a bootstrap voltage generator 400 as illustrated in FIG. 15. The bootstrap voltage generator 400 may be provided at one side of the display panel 100. The bootstrap voltage generator 400 may be provided on the same substrate as that of the display panel 100 or may be provided at an outer side of the display panel 100.

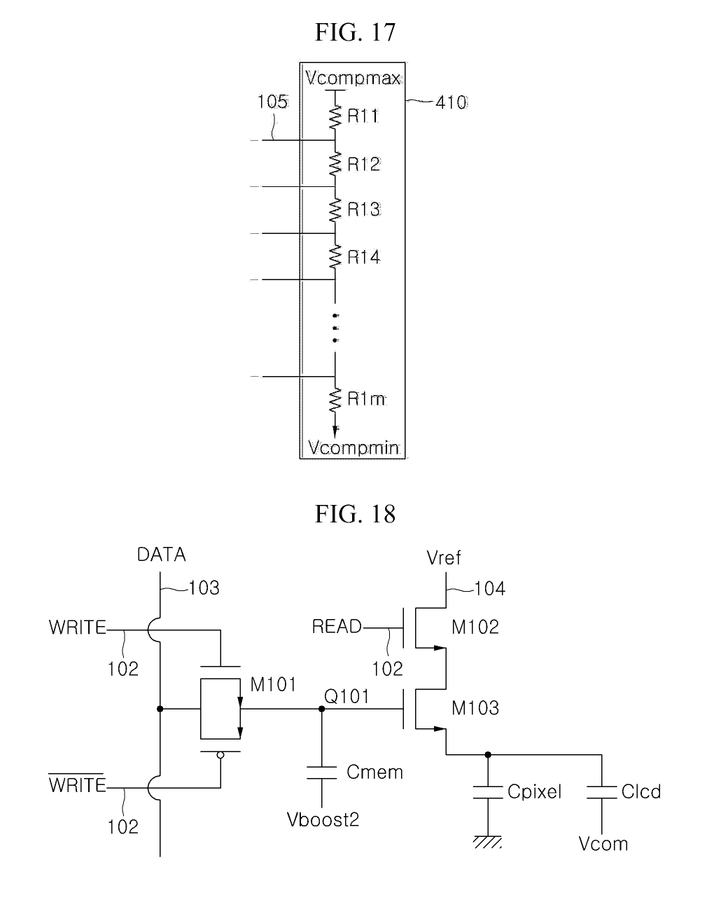

Also, according to a column direction position of the pixel 101, i.e., according to arrangement of the pixels 101 from top to bottom, different bootstrap voltages Vboost1 may be provided. This is because image data are provided from top to bottom, and thus image data charged in memory capacitors Cmem of upper pixels 101 are discharged for a longer time. Therefore, upper pixels 101 are more discharged than lower pixels 101. Therefore, since a voltage of the pixel capacitor Cpixel or the liquid crystal capacitor Clcd charged in proportion to a voltage of the memory capacitor Cmem is varied with a position of the pixel 101, the variance should be compensated by applying different bootstrap voltages Vboost1 according to a position of the pixel 101. To this end, a voltage divider 410 may be provided for dividing the bootstrap voltage generated from the bootstrap voltage generator as illustrated in FIG. 16. That is, the voltage divider 410 is provided between the display unit 110 and the bootstrap voltage generator 400 to provide different bootstrap voltages Vboost1 according to positions of pixels. For the voltage divider 410, a plurality of resistors R11 to R1m are connected to each other in series between a voltage Vcompmax to be maximally compensated and a voltage Vcompmin to be minimally compensated, and the bootstrap voltage supply line 105 connected to pixels in a horizontal direction is connected to each connection between resistors so as to divide a voltage as illustrated in FIG. 17.

Meanwhile, as described above, since image data are sequentially applied from top to bottom, image data charged in the memory capacitor Cmem of an upper pixel 101 is discharged for a longer time in comparison with image data charged in the memory capacitor Cmem of a lower pixel 101. Therefore, the pixel capacitor Cpixel or the liquid crystal capacitor Clcd charged in proportion to a voltage of the memory capacitor Cmem has a different value according to a position of the pixel 101 even in the case of the same image data. For compensating for this, as illustrated in FIG. 18, a bootstrap voltage Vboost2 is applied right before the read signal READ is applied to the memory capacitor Cmem, and the ground voltage Vss is applied after the read signal READ is applied.

Also, according to a column direction position of the pixel 101, i.e., according to arrangement of the pixels 101 from top to bottom, different bootstrap voltages Vboost2 may be applied to the memory capacitor Cmem. Since an upper pixel 101 is more discharged than a lower pixel 101, a relatively higher bootstrap voltage should be applied to compensate for this. To this end, as illustrated in FIG. 16, the voltage divider 410 configured to divide the bootstrap voltage Vboost2 generated from the bootstrap voltage generator 400 may be provided.

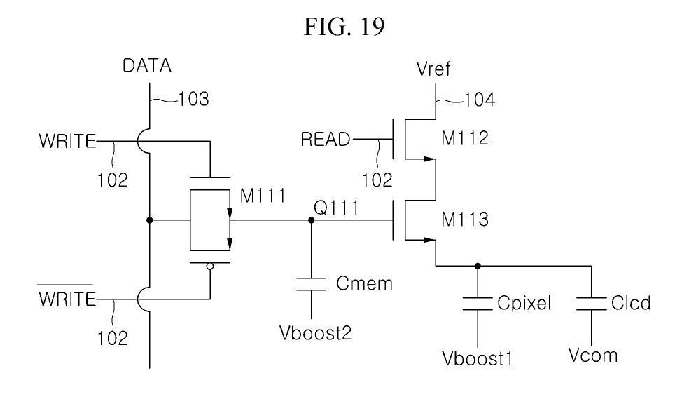

Further, as illustrated in FIG. 19, the bootstrap voltages Vboost1 and Vboost2 may be respectively applied to the pixel capacitor Cpixel and the memory capacitor Cmem. Also in this case, according to arrangement of the pixels 101 from top to bottom, different bootstrap voltages Vboost1 and Vboost2 may be applied to the pixel capacitor Cpixel and the memory capacitor Cmem. In this case, the voltage divider 410 may be used as described above referring to FIGS. 16 and 17.

According to the exemplary embodiments, the frame buffer pixel circuit discharges electric charges corresponding to previous image data which are accumulated in a liquid crystal capacitor by applying a reference voltage as a ground voltage during a predetermined period when a read signal is activated, and charges electric charges corresponding to current image data in the liquid crystal capacitor by applying the reference voltage as a power supply voltage during a remaining period when the read signal is deactivated.

Therefore, a pull-down transistor is not required to discharge electric charges accumulated in the liquid crystal capacitor, thus enabling to reduce pixel size without size decrease in pixel aperture.

In addition, since charge-sharing between the memory capacitor and the liquid crystal capacitor does not occur and a transistor having the minimum size can be used, it is possible to minimize charges induced in a pixel electrode.

Furthermore, a reference voltage can be commonly applied to all pixels as well as pixels selected in synchronization with a read signal, thereby making it possible to realize discharge and charge operations of the liquid crystal capacitor within one cycle. Consequently, a control circuit for driving pixels can be simply constructed.

Although the frame buffer pixel circuit, method of operating the same, and display device having the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A frame buffer pixel circuit, comprising:
a first switching unit configured to transfer image data in response to a first actuating signal;
a first charging unit configured to charge the image data;
a second switching unit configured to supply a reference voltage in response to a second actuating signal;
a third switching unit configured to adjust and transfer the reference voltage according to a charge amount; and
a second charging unit configured to charge or discharge according to the reference voltage,
wherein the reference voltage is capable of being supplied as a discharge voltage discharging the second charging unit and a charge voltage charging the second charging unit.

2. The frame buffer pixel circuit of claim 1, wherein the first switching unit comprises an N-type transistor, a P-type transistor, or a transmission gate.

3. The frame buffer pixel circuit of claim 1, wherein the first charging unit is a memory capacitor formed on a substrate, and the second charging unit comprises a pixel capacitor coupled to the memory capacitor.

4. The frame buffer pixel circuit of claim 3, wherein the memory capacitor and the pixel capacitor each comprising a capacitor structure including an insulation layer disposed between a diffusion layer and a conductive layer, a capacitor structure including a conductive material and an insulating material disposed within a trench, or a capacitor structure including an insulation layer disposed between conductive layers.

5. The frame buffer pixel circuit of claim 4, wherein the conductive layer comprises doped polysilicon or metal.

6. The frame buffer pixel circuit of claim 3, wherein a bootstrap voltage is configured to be supplied to at least one of the pixel capacitor and the memory capacitor.

7. The frame buffer pixel circuit of claim 1, wherein the second and third switching units comprise an N-type transistor or a P-type transistor.

8. The frame buffer pixel circuit of claim 7, wherein a gate-source voltage of the third switching unit is configured higher than a threshold voltage of the third switching unit such that a discharge current can flow through the second switching unit.

9. The frame buffer pixel circuit of claim 1, wherein the first actuating signal is a write signal and the second actuating signal is a read signal.

10. The frame buffer pixel circuit of claim 9, wherein the second switching unit is configured to supply the discharge voltage for a first time after the second actuating signal is activated and is configured to supply the charge voltage for a second time after the first time.

11. A method of operating a frame buffer pixel circuit, comprising:
charging data of a current image in response to a first actuating signal;
discharging data of a previous image by supplying a discharge voltage for a first time of a second actuating signal; and
supplying a charge voltage for a second time of the second actuating signal after the first time,
wherein the data of the current image is charged adjusting a supply amount of the charge voltage according to the data of the current image.

12. The method of claim 11, wherein the second actuating signal is activated after the first actuating signal is deactivated.

13. The method of claim 12, further comprising supplying a bootstrap voltage before or after applying the second actuating signal by supplying next image data.

14. A display device, comprising:
a display panel comprising a display unit where a plurality of pixels are arranged in a matrix form, a row driver configured to supply first and second actuating signals for selecting the pixels, and a column driver configured to supply image data to the selected pixels;
a display control unit configured to supply the first and second actuating signals and the image data for driving the display panel; and
a voltage generation unit configured to generate a charge voltage and a discharge voltage,
wherein each of the pixels comprises a frame buffer pixel circuit comprising a first charging unit configured to charge the image data and a second charging unit configured to charge according to the charge voltage adjusted according to the image data charged in the first charging unit, wherein the second charging unit is configured to discharge data of a previous image by coupling the discharge voltage before data of a current image are applied and is configured to charge the data of the current image by coupling the charge voltage.

15. The display device of claim 14, wherein the frame buffer pixel circuit comprises:
a first switching unit configured to transfer the image data to the first charging unit in response to the first actuating signal;
a second switching unit configured to supply the discharge voltage or the charge voltage to the second charging unit in response to the second actuating signal; and
a third switching unit configured to adjust the charge voltage according to a charge amount of the first charging unit and configured to transfer the adjusted charge voltage to the second charging unit.

16. The display device of claim 15, wherein the third switching unit comprises an N-type transistor or a P-type transistor in which a gate-source voltage is configured higher than a threshold voltage.

17. The display device of claim 16, wherein the third switching unit is capable of supplying the discharge voltage to the second charging unit regardless of the charge amount of the first charging unit for the second charging unit to discharge the data of the previous image.

18. The display device of claim 14, further comprising a bootstrap voltage generation unit configured to supply a bootstrap voltage to at least one of the first and second charging units.

19. The display device of claim 18, further comprising a bootstrap voltage divider configured to differently apply the bootstrap voltage to the pixels between the display unit and the bootstrap voltage generation unit.
